(19) United States
(12) Patent Application Publication
(10) Pub. No.: US 2009/0147094 A1
(43) Pub. Date: Jun. 11, 2009

(54) DIGITAL IMAGING DEVICE CAPABLE OF AUTO-REGULATING BRIGHTNESS OF DISPLAY PANEL AND BRIGHTNESS AUTO-REGULATING METHOD THEREOF

(75) Inventor: HUNG-YUAN CHIANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/205,926

(22) Filed: Sep. 8, 2008

(30) Foreign Application Priority Data
Dec. 5, 2007 (CN) 200710202852.9

(51) Int. Cl. H04N 5/228; G09G 5/10

(52) U.S. Cl. 348/222.1; 345/690; 348/E05.031

(57) ABSTRACT

A digital imaging device includes a display panel, a capturing unit for capturing a number of images including a current image and a subsequent image, a brightness measuring unit configured for measuring a brightness value of the current image, a judging unit configured for determining whether the measured brightness value is acceptable, a controller, a memory and a regulating unit. The controller is used for adjusting exposure parameters of the capturing unit for the subsequent image if the measured brightness value is not acceptable. The memory stores a table including a collection of brightness values and a collection of driving voltage values, wherein each brightness value is associated with a driving voltage value. The regulating unit is used for indexing a driving voltage value in the table associated with the measured brightness value, and adjusting the display panel according to the indexed driving voltage value if the measured brightness value is acceptable.

### BACKGROUND

1. Technical Field

The present invention relates to imaging systems and, particularly, to an imaging device capable of auto-regulating brightness of a display panel and a brightness auto-regulating method thereof.

2. Description of the Related Art

Digital imaging devices with display panels are popular due to their convenience in allowing people to preview pictures on imaging devices. These imaging devices may be used in various ambient light conditions, wherein different ambient light conditions require different levels of brightness of the display panels for comfortable viewing. Unfortunately, most imaging devices require inconvenient manual adjustments to the brightness level of the display panels.

### BRIEF DESCRIPTION OF THE DRAWINGS

Many aspects of the present imaging device and method can be better understood with references to the accompanying drawings. The components in the drawings are not necessarily drawn to scale, the emphasis instead being placed upon clearly illustrating the principles of the present digital imaging device and method. Moreover, in the drawings, like reference numerals designate corresponding parts throughout the several views.

FIG. 1 shows a functional block diagram of a digital imaging system in accordance with an exemplary embodiment.

FIG. 2 is a flowchart of a method for auto-regulating brightness of a digital imaging device in accordance with another embodiment.

### DETAILED DESCRIPTION OF THE EMBODIMENTS

Embodiments of the present digital imaging device and method will now be described in detail below with references to the drawings.

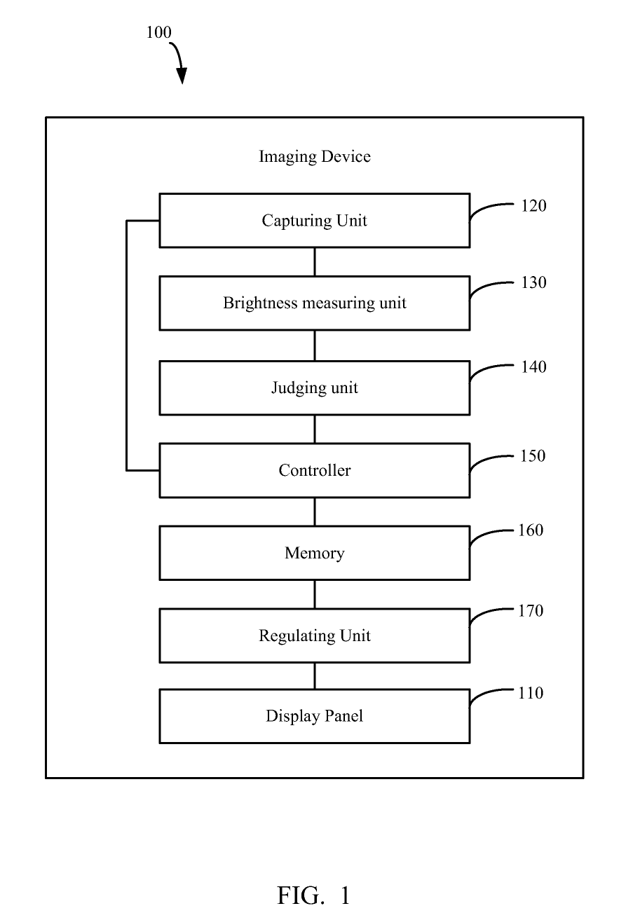

Referring to FIG. 1, a digital imaging device 100 in accordance with an exemplary embodiment includes a display panel 110, a capturing unit 120, a brightness measuring unit 130, a judging unit 140, a controller 150, a memory 160, and a regulating unit 170. The capturing unit 120 is used for capturing a number of images that include a current image and a subsequent image. The brightness measuring unit 130 is configured for measuring a brightness value of the current image. The judging unit 140 is configured for judging whether the measured brightness value is acceptable. The controller 150 is configured for adjusting exposure parameters of the capturing unit 120 for the subsequent image if the measured brightness value is not acceptable. The memory 160 stores a table including a collection of brightness values and a collection of driving voltage values, wherein each brightness value is associated with a driving voltage value. The regulating unit 170 is configured for indexing a driving voltage value in the table associated with the measured brightness value, and adjusting the display panel 110 according to the indexed driving voltage value if the measured brightness value is acceptable.

The capturing unit 120 includes an exposure section and an image sensor. The exposure section is configured for regularly exposing the image sensor. Specifically, the exposure section includes a fixed diaphragm with a fixed aperture N (f-number), or an iris diaphragm with variable aperture N controllable by controller 120. The exposure section exposes the image sensor for an exposure time (shutter speed) T in seconds. The image sensor can be exposed using a fixed ISO speed rating S, or different ISO speed rating S controlled by the controller 150. The exposure parameters include the ISO speed rating S, the f-number N, and the exposure time T.

The brightness measuring unit 130 measures the brightness value of the current image using the following equations: Ev=Bv+Sv=Av+Tv; Sv=log₂(0.3S); Av=2 log₂N; and Tv=log₂(1/T), where Ev, Bv, Sv, Av, and Tv represent an exposure value, the brightness value, a speed value, an aperture value, and a time value of the capturing unit, respectively.

The memory 160 further stores a predetermined brightness value. The judging unit 140 determines the measured brightness value is acceptable if the measured brightness value is approximately equal to the predetermined brightness value. In this situation, the exposure parameters of the capturing unit 120 for capturing the current image are used for capturing the subsequent image. The predetermined brightness value may vary depending on the manufacturer and/or type of digital imaging device.

The judging unit 140 determines the measured brightness value is not acceptable if the measure brightness value is not approximately equal to the predetermined brightness value. In this situation, the controller 150 adjusts exposure parameters of the capturing unit 120 for the subsequent image. After the adjustment of the exposure parameters, the capturing unit 120 captures the subsequent image using the adjusted exposure parameters. The brightness measuring unit 130 measures a brightness value of the subsequent image, and the judging unit 140 determines whether the measured brightness value of the subsequent image is acceptable by comparing the measure brightness value of the subsequent image to the predetermined brightness value in the memory 160. If so, the subsequent image is captured by the capturing unit 120 using the adjusted exposure parameters.

When the measured brightness value of the image is acceptable, the regulating unit 170 indexes a driving voltage value associated with the acceptable measured brightness value in the table, and adjusts the brightness of the display panel 110 according to the indexed driving voltage value. As a result, the brightness of the display panel 110 is adjusted based on the brightness of the current ambient light condition.

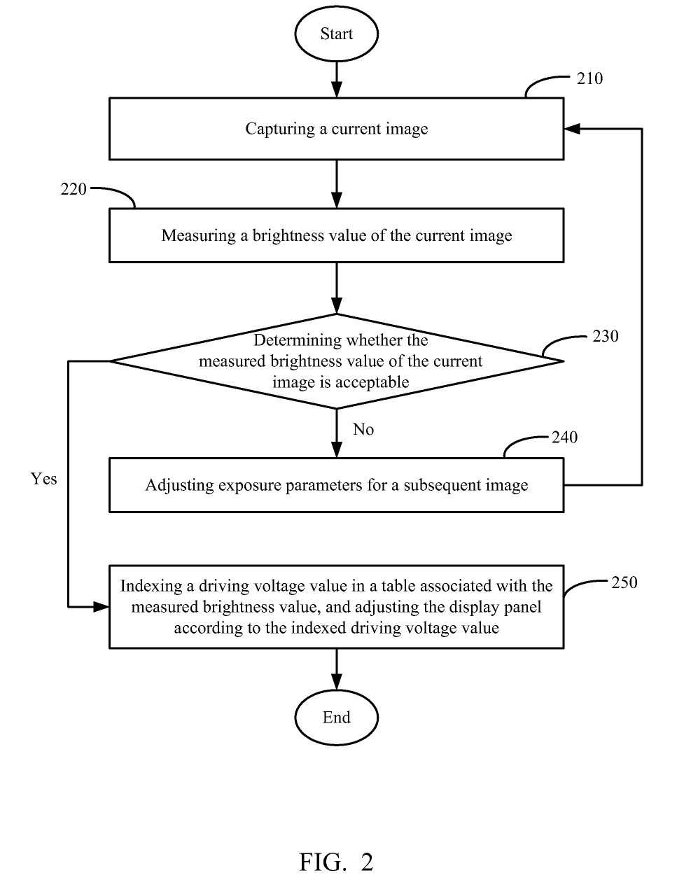

Referring to FIG. 2, a method for auto-regulating the brightness of the display panel 110 of the digital imaging device 100 in accordance with another exemplary embodiment includes steps 210 through 250. Step 210: capturing a current image. Step 220: measuring a brightness value of the current image. Step 230: determining whether the measured brightness value of the current image is acceptable. Step 240: adjusting exposure parameters for a subsequent image if the measured brightness value of the current image is not acceptable, and performing Steps 210 and 230. Step 250: indexing a driving voltage value in a table associated with the measured brightness value, and adjusting the display panel according to the indexed driving voltage value if the measured brightness value is acceptable.

Specifically, the exposure parameters of the capturing unit 120 include the ISO speed rating S, the f-number N, and the exposure time T. The brightness value of the current image is measured by the brightness measuring unit 130 using the following equations: Ev=Bv+Sv=Av+Tv; Sv=log₂(0.3S); Av=2 log₂N; and Tv=log₂(1/T), where Ev, Bv, Sv, Av, and Tv respectively represent an exposure value, the brightness value, a speed value, an aperture value, and a time value of the capturing unit. The table includes a collection of brightness values and a collection of driving voltage values, wherein each brightness value is associated with a driving voltage value.

The controller 150 adjusts the exposure parameters of the capturing unit 120 for the subsequent image if the measured brightness value is not acceptable. The capturing unit 120 captures the subsequent image using the adjusted exposure parameters.

If the measured brightness value of the current image is acceptable, the capturing unit 120 captures the subsequent image using the exposure parameters for the current image. The regulating unit 170 indexes a driving voltage value associated with the acceptable measured brightness value, and adjusts the display panel 110 according to the indexing driving voltage value.

It will be understood that the above embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A digital imaging device comprising:
a display panel;
a capturing unit for capturing a plurality of images that include a current image and a subsequent image;
a brightness measuring unit configured for measuring a brightness value of the current image;
a judging unit configured for determining whether the measured brightness value is acceptable;
a controller configured for adjusting exposure parameters of the capturing unit for the subsequent image if the measured brightness value is not acceptable;
a memory storing a table comprising a collection of brightness values and a collection of driving voltage values, wherein each brightness value is associated with a driving voltage value; and
a regulating unit configured for indexing a driving voltage value in the table associated with the measured brightness value, and adjusting the display panel according to the indexed driving voltage value if the measured brightness value is acceptable.

2. The digital imaging device as claimed in claim 1, wherein the memory further stores a predetermined brightness value, and the judging unit determines the measured brightness value is acceptable if the measure brightness value is approximately equal to the predetermined brightness value.

3. The digital imaging device as claimed in claim 1, wherein the exposure parameters comprise an ISO speed rating, an f-number, and an exposure time.

4. The digital imaging device as claimed in claim 3, wherein the brightness measuring unit measures the brightness value of the current image using the following equations:
Ev=Bv+Sv=Av+Tv;
Sv=log₂(0.3S);
Av=2 log₂N; and
Tv=log₂(1/T),
Where Ev, Bv, Sv, Av, and Tv respectively represent an exposure value, a brightness value, a speed value, an aperture value, and a time value of the capturing unit, S, N, and T respectively represent the ISO speed rating, the f-number and the exposure time.

5. A method for auto-regulating brightness of a display panel, the method comprising:
(a) capturing a current image;
(b) measuring a brightness value of the current image;
(c) determining whether the measured brightness value is acceptable;
(d) adjusting exposure parameters and performing step (a) if the measured brightness value is not acceptable; and
(e) indexing a driving voltage value in a table associated with the measured brightness value, and adjusting the display panel according to the indexed driving voltage value if the measured brightness value is acceptable.

6. The method as claimed in claim 5, wherein the exposure parameters comprise an ISO speed rating, an f-number, and an exposure time.

7. The method as claimed in claim 6, wherein the brightness value is measured using the equations:
Ev=Bv+Sv=Av+Tv;
Sv=log₂(0.3S);
Av=2 log₂N; and
Tv=log₂(1/T),
Where Ev, Bv, Sv, Av, and Tv respectively represent an exposure value, the brightness value, a speed value, an aperture value, and a time value; S, N, and T respectively represent the ISO speed rating, the f-number and the exposure time.

8. The method as claimed in claim 5, wherein the table in step (e) comprises a collection of brightness values and a collection of driving voltage values, wherein each brightness value is associated with a driving voltage value.
